(19) United States
(12) Patent Application Publication
(10) Pub. No.: US 2014/0265811 A1
(43) Pub. Date: Sep. 18, 2014

(54) LED LIGHT BULB WITH A PHOSPHOR STRUCTURE IN AN INDEX-MATCHED LIQUID

(71) Applicant: Switch Bulb Company, Inc., San Jose, CA (US)

(72) Inventor: Ronan LE TOQUIN, Sunnyvale, CA (US)

(73) Assignee: SWITCH BULB COMPANY, INC., San Jose, CA (US)

(21) Appl. No.: 13/842,260

(22) Filed: Mar. 15, 2013

(51) Int. Cl. F21V 29/00

(52) U.S. Cl. CPC F21V 29/004
USPC 313/35; 29/592.1

(57) ABSTRACT

A liquid-filled LED bulb including a base and a shell connected to the base forming an enclosed volume. The liquid-filled LED bulb also includes a plurality of LEDs attached to the base and disposed within the enclosed volume. A thermally conductive liquid is held within the enclosed volume and has a first index of refraction. The LED bulb also includes a ring structure disposed within the enclosed volume and immersed in the thermally conductive liquid. The ring structure has a second index of refraction that matches the first index of refraction. A phosphor material is disposed on, or dispersed within, the ring structure. A first amount of the thermally conductive liquid is disposed between the LEDs and the ring structure and a second amount of the thermally conductive liquid is disposed between the ring structure and the shell.

### BACKGROUND

1. Field

The present disclosure relates generally to light-emitting diode (LED) bulbs, and more particularly, to an LED bulb that has a phosphor structure in an index-matched, thermally conductive liquid.

2. Related Art

Traditionally, lighting has been generated using fluorescent and incandescent light bulbs. While both types of light bulbs have been reliably used, each suffers from certain drawbacks. For instance, incandescent bulbs tend to be inefficient, using only 2-3% of their power to produce light, while the remaining 97-98% of their power is lost as heat. Fluorescent bulbs, while more efficient than incandescent bulbs, do not produce the same warm light as that generated by incandescent bulbs. Additionally, there are health and environmental concerns regarding the mercury contained in fluorescent bulbs.

Thus, an alternative light source is desired. One such alternative is a bulb utilizing an LED. An LED comprises a semiconductor junction that emits light due to an electrical current flowing through the junction. Compared to a traditional incandescent bulb, an LED bulb is capable of producing more light using the same amount of power. Additionally, the operational life of an LED bulb is orders of magnitude longer than that of an incandescent bulb, for example, 10,000-100,000 hours as opposed to 1,000-2,000 hours.

While there are many advantages to using an LED bulb rather than an incandescent or fluorescent bulb, LEDs have a number of drawbacks that have prevented them from being as widely adopted as incandescent and fluorescent replacements. One drawback is that an LED, being a semiconductor, generally cannot be allowed to get hotter than approximately 120° C. As an example, A-type LED bulbs have been limited to very low power (i.e., less than approximately 8 W), producing insufficient illumination for incandescent or fluorescent replacements.

One approach to alleviating the heat problem of LED bulbs is to fill an LED bulb with a thermally conductive liquid, to transfer heat from the LEDs to the bulb's shell. The heat may then be transferred from the shell out into the air surrounding the bulb.

Another drawback to an LED bulb is that LEDs tend to produce light that has a relatively narrow emission band with respect to the entire visible color spectrum. For example, one type of LED, based on gallium nitride (GaN), efficiently emits light over a relatively narrow emission profile centered at a peak wavelength in the blue region of the visible spectrum (approximately 450 nm). GaN LEDs are typically used because they can provide significantly brighter output light than other types of LEDs. However, the relatively narrow emission band, having a primarily blue color, may not produce the desired illumination qualities.

A phosphor material can be used to control the light emitted from an LED. Typically, a phosphor material absorbs LED light at a first wavelength, and emits light at a second wavelength. The phosphor material can be selected so that the emitted wavelength provides the desired color properties. It may be advantageous for an LED bulb to use a phosphor material to convert the convert the narrow band of emitted wavelengths from an LED into a broader or color-shifted emission spectrum. In particular, it may be advantageous to use a phosphor material to increase the wavelength of the light emitted from an LED bulb to produce a red-shifted emission spectrum.

### SUMMARY

In one exemplary embodiment, a liquid-filled LED bulb includes a base and a shell connected to the base to form an enclosed volume. The liquid-filled LED bulb also includes a plurality of LEDs attached to the base and disposed within the enclosed volume. A thermally conductive liquid is held within the enclosed volume and has a first index of refraction. The LED bulb also includes a ring structure disposed within the enclosed volume and immersed in the thermally conductive liquid. The ring structure has a second index of refraction that matches the first index of refraction. A phosphor material is disposed on, or dispersed within, the ring structure. A first amount of the thermally conductive liquid is disposed between the LEDs and the ring structure and a second amount of the thermally conductive liquid is disposed between the ring structure and the shell. In some cases, the second index of refraction of the ring structure is matched within 10 percent of the first index of refraction of the thermally conductive liquid. In some cases, at least one of the plurality of LEDs has a third index of refraction, and the first index of refraction of the thermally conductive liquid is matched within 40 percent of the third index of refraction of the at least one LED.

In some embodiments, the ring structure is configured to facilitate a flow of the thermally conductive liquid from the LED to an inner surface of the shell. The flow of thermally conductive liquid may be caused, at least in part, by passive convection. In some embodiments, an inside surface of the ring structure is positioned a fixed distance from a light-emitting face of at least one of the plurality of LEDs to facilitate a flow of the thermally conductive liquid from the LED to an inner surface of the shell. In some embodiments, an outside surface of the ring structure is positioned a fixed distance from an inner surface of the shell to facilitate a flow of the thermally conductive liquid from the LED to an inner surface of the shell.

In some embodiments, the phosphor material is configured to absorb light produced by the LEDs having a first wavelength and is configured to emit light at a second wavelength, the second wavelength being longer than the first wavelength. The phosphor material may be disposed on an external surface of the ring structure. The phosphor material may also be disposed on an internal surface of the ring structure.

### DESCRIPTION OF THE FIGURES

FIG. 1 depicts a perspective view of an exemplary LED bulb.

FIG. 2 depicts a cross-sectional view of an exemplary LED bulb with a ring structure having a phosphor material.

FIGS. 3A and 3B depict cross-sectional views of an exemplary LED bulb.

FIGS. 4A and 4B depict cross-sectional views of an exemplary LED bulb with a ring structure.

FIG. 5 depicts an exemplary LED bulb with a ring structure.

FIGS. 6A and 6B depict an exemplary ring structure.

FIGS. 7A and 7B depict an exemplary ring structure.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

### 1. Liquid-Filled LED Bulb

As used herein, an “LED bulb” refers to any light-generating device (e.g., a lamp) in which at least one LED is used to generate light. Thus, as used herein, an “LED bulb” does not include a light-generating device in which a filament is used to generate the light, such as a conventional incandescent light bulb. It should be recognized that the LED bulb may have various shapes in addition to the bulb-like A-type shape of a conventional incandescent light bulb. For example, the bulb may have a tubular shape, globe shape, or the like. The LED bulb of the present disclosure may further include any type of connector; for example, a screw-in base, a dual-prong connector, a standard two- or three-prong wall outlet plug, bayonet base, Edison Screw base, single-pin base, multiple-pin base, recessed base, flanged base, grooved base, side base, or the like.

For convenience, all examples provided in the present disclosure describe and show an LED bulb being a standard A-type form factor bulb. However, as mentioned above, it should be appreciated that the present disclosure may be applied to LED bulbs having any shape, such as a tubular bulb, a globe-shaped bulb, or the like.

FIGS. 1 and 2 depict an exemplary LED bulb having a thermally conductive liquid and a ring structure. FIG. 1 depicts the LED bulb 100 in a perspective view and FIG. 2 depicts the LED bulb 100 in a detail cross-sectional view. As shown in FIGS. 1 and 2, LED bulb 100 includes a base 113 and a shell 101, encasing LEDs 103.

Shell 101 may be made from any transparent or translucent material such as plastic, glass, polycarbonate, or the like. Shell 101 may include dispersion material spread throughout the shell to disperse light generated by LEDs 103. The dispersion material prevents LED bulb 100 from appearing to have one or more point sources of light.

As shown in FIGS. 1 and 2, LED bulb 100 includes a plurality of LEDs 103 attached to LED mounts 105. LED mounts 105 may be made of any thermally conductive material, such as aluminum, copper, brass, magnesium, zinc, or the like. Since LED mounts 105 are formed of a thermally conductive material, heat generated by LEDs 103 may be conductively transferred to LED mounts 105. Thus, LED mounts 105 may act as a heat-sink or heat-spreader for LEDs 103. LED mounts 105 may be configured to have channels or openings between each LED mount 105 to allow the passage of fluid. Example LED mounts 105 may include, but are not limited to, finger-shaped protrusions or posts.

In FIGS. 1 and 2, LED mounts 105 have an angled face for attaching LEDs 103. The angled face of LED mounts 105 may be directed inward towards the center of LED bulb 100. The angled face of LED mounts 105 may also facilitate the passive convective flow of liquids within LED bulb 100. In another embodiment, LEDs 103 may be mounted on the top portions of LED mounts 105.

As shown in FIG. 1, base 113 of LED bulb 100 includes connector 115 for connecting the bulb to a lighting fixture. Base 113 of LED bulb 100 also includes heat-spreader 117. Heat-spreader 117 may be made of any thermally conductive material, such as aluminum, copper, brass, magnesium, zinc, or the like. Heat-spreader 117 may be thermally coupled to one or more of shell 101, LED mounts 105, and/or a thermally conductive liquid disposed in volume 111. Thermal coupling allows some of the heat generated by LEDs 103 to be conducted to and dissipated by heat-spreader 117. Preferably, LED bulb 100 is configured so that the operating temperature of heat spreader 113 is limited to temperatures that are safe to human touch, given the external placement of heat spreader 117.

As shown in FIGS. 1 and 2, the shell 101 and base 113 of LED bulb 100 interact to define an enclosed volume 111, which is filled with a thermally conductive liquid. As used herein, the term “liquid” refers to a substance capable of flowing. Also, the substance used as the thermally conductive liquid is a liquid or at the liquid state within, at least, the operating, ambient-temperature range of the bulb. An exemplary temperature range includes temperatures between −40° C. to +40° C. The thermally conductive liquid may be mineral oil, silicone oil, glycols (PAGs), fluorocarbons, or other material capable of flowing. It may be desirable to have the liquid chosen be a non-corrosive dielectric. Selecting such a liquid can reduce the likelihood that the liquid will cause electrical shorts and reduce damage done to the components of LED bulb 100.

It may also be desirable for thermally conductive liquid to have a large coefficient of thermal expansion to facilitate passive convective flow. As used herein, “passive convective flow” refers to the circulation of a liquid without the aid of a fan or other mechanical devices driving the flow of the thermally conductive liquid. A more detailed description of passive convective flow in an LED bulb is provided in Section 3, below.

### 2. Ring Structure

FIG. 2 depicts a cross-sectional view of a ring structure 140 surrounding the LEDs 103. In FIG. 1, the ring structure 140 is depicted using a dashed outline to better illustrate components of the LED bulb 100 that may otherwise be hidden by the ring structure 140. As shown in FIG. 2, the ring structure 140 is also located within the enclosed volume 111, and is immersed in the thermally conductive liquid. That is, a first amount of the thermally conductive liquid is disposed between the LED 103 and the ring structure 140. Another, second amount of the thermally conductive liquid is disposed between the ring structure 140 and the shell 101.

A phosphor material is deposed on or dispersed within the ring structure 140. As mentioned above, a phosphor material can be used to absorb light produced by the LEDs 103 at a first wavelength and emit light at a different, second wavelength. Accordingly, a phosphor material can be used to control the wavelength of light emitted from the LED bulb 100.

To improve optical efficiency of the LED bulb, the optical materials of the LED bulb 100 may be selected to minimize back reflection. In general, back reflection refers to an amount of light that is reflected back toward a source due to an optical interface between two materials. The amount of back reflection that occurs at an optical interface depends, at least in part, on the difference in the indices of refraction for the two materials at the optical interface. Typically, when the difference between the indices is reduced, the amount of back reflection is also reduced.

To minimize back reflection at the optical interface between the LEDs 103 and the thermally conductive liquid, the thermally conductive liquid is selected to have an index of refraction that is between the index of refraction of the LED and the index of refraction of air (1.0). In some cases, the thermally conductive liquid has an index of refraction that is matched within 40 percent of the index of refraction of the LED. For example, an LED made from GaN may have an index of refraction of approximately 2.2. A thermally conductive liquid may be selected having an index of refraction of approximately 1.45, which is within approximately 35 percent of the index of refraction of the LED.

To reduce back reflection at optical interfaces between the thermally conductive liquid and the ring structure 140, the ring structure 140 has an index of refraction that matches the index of refraction of the thermally conductive liquid. The index of refraction of the ring structure is considered matched if the index of refraction is matched within 10% of the index of the thermally conductive liquid. For example, if the thermally conductive liquid has and index of refraction of approximately 1.45, the index of refraction of the ring structure 140 may have an index of refraction ranging between approximately 1.3 and 1.6 and still be considered matched to the index of the liquid.

The index of refraction of the ring structure 140, as discussed herein, does not include the index of refraction of the phosphor material. In some cases, the phosphor material integrated with the ring structure 140 may have a different index of refraction than the ring structure 140. For example, the phosphor material may have an index of refraction of approximately 1.8. In some cases, the phosphor material is selected to have an index of refraction that matches the index of refraction of the thermally conductive liquid.

There are a number of advantages to using a ring structure that is spatially separated from the surface of the LED and that is index-matched to a surrounding thermally conductive liquid. One advantage is that the ring structure provides a relatively large surface area for applying a phosphor material, as compared to the surface area of the LED. Light emitted from an LED 103 propagates along a roughly conical light path that becomes wider as the light travels further from the LED 103. That is, as the light propagates away from the LED, approximately the same number of emitted photons is spread over a larger area. By placing the phosphor material further along the conical light path, a larger area of phosphor can be used for approximately the same number of photons. In some cases, the effectiveness of the phosphor material can be improved by increasing the phosphor to photon ratio.

Another advantage of using a spatially separated ring structure that is index-matched to a surrounding thermally conductive liquid is that light reflected back from the phosphor is at least some distance away from the surface of the LED. As described above, the back reflection may occur due to different indices at the optical interface between materials. The phosphors may also emit light back toward the LEDs, when the phosphors are stimulated. This light emitted by the phosphors at a different wavelength may also be considered reflected light. The further away these reflections occur, the less light that will be reflected back on (and absorbed by) the surface of the LED. Reducing light absorbed by the LED may reduce the thermal load on the LED and increase the overall light output of the LED bulb.

As described in more detail below, the thermally conductive liquid provides cooling for the LED via passive convective currents. The thermally conductive liquid also provides cooling for the phosphor material integrated with the ring structure. To allow for liquid cooling, the ring structure may also facilitate the flow of passive convective currents in the thermally conductive liquid. Exemplary ring structures that facilitate passive convective flow are described in more detail below in Section 3.

An LED bulb 100 using a thermally conductive liquid to cool the LEDs can produce light equivalent to standard incandescent bulbs. In some embodiments, the LED bulb 100 may use 6 W or more of electrical power to produce light equivalent to a 40 W incandescent bulb. In some embodiments, the LED bulb 100 may use 20 W or more to produce light equivalent to or greater than a 75 W incandescent bulb. Depending on the efficiency of the LED bulb 100, between 4 W and 16 W of heat energy may be produced when the LED bulb 100 is illuminated.

### 3. Placement of a Ring Structure in a Liquid-Filled LED Bulb

As described above, there are multiple advantages to integrating a phosphor material with a structure that is spatially separated from the LED. There are also advantages to using a phosphor structure that is immersed in an index-matched, thermally conductive liquid. When such a structure is used in a liquid-filled LED bulb, the structure may be placed within the LED bulb in a way that does not significantly alter the performance of the LED bulb. Specifically, the ring structure may be shaped to capture light emitted by the LEDs without significantly interfering with passive convective currents of the thermally conductive liquid. In this way, the ring structure can be used to alter the optical qualities of the light emitted by the LED bulb while facilitating flow of the thermally conductive liquid. Exemplary ring structure shapes are depicted in FIGS. 4 through 7A and B and discussed below.

As mentioned above, a liquid-filled LED bulb may use a thermally conductive liquid to transfer heat from the LEDs to the bulb's shell via passive convection. To facilitate passive convective flow, the thermally conductive liquid may have a large coefficient of thermal expansion. FIGS. 3A and 3B depict an exemplary passive convective flow of the thermally conductive liquid within the enclosed volume 111. As cells of thermally conductive liquid near the LEDs 103 and LED mounts 105 are heated, the cells of thermally conductive liquid become less dense and tend to rise within the enclosed volume 111. Cells of thermally conductive liquid near the shell 101 or base 113 may become cooler as the shell 101 or base 113 absorb heat from the thermally conductive liquid. As the cells of the thermally conductive liquid cool near the shell 101 or base 113, the cells become denser and tend to sink within the enclosed volume 111.

Due to the heat exchange between the LEDs 103, LED mounts 105, shell 101, and base 113, passive convective currents tend to flow as indicated by the arrows in FIGS. 3A and 3B. FIG. 3A depicts exemplary passive convective currents when the LED bulb 100 is in an upright position and FIG. 3B depicts exemplary passive convective currents when the LED bulb 100 is in an inverted position.

As shown in FIGS. 3A and 3B, the motion of the cells of the thermally conductive liquid may be further distinguished by zones with cells that are moving in the same direction, and dead zones 130, i.e., zones between cells of liquid that are moving in opposite directions. Within a dead zone 130, the shear force between cells of liquid moving in one direction and cells of liquid moving in the opposite direction slows the convective flow of liquid within the dead zone 130, such that liquid in dead zones 130 may not significantly participate in the convective flow nor efficiently carry heat away from the LEDs 103.

Because cells of the thermally conductive liquid within the dead zones 130 do not significantly participate in the convective heat transfer, the dead zones 130 may be suitable locations for placing a structure containing a phosphor material.

For example, as explained in more detail below, a ring structure including a phosphor material can be placed in the dead zones 130 to alter the spectral emissions of the LED bulb. By placing the ring structure in or near the dead zones 130, the ring structure can be used to alter the emission spectrum of the LED bulb 100 while facilitating convective heat transfer by the thermally conductive liquid. That is, in some embodiments, the ring structure can be placed within enclosed volume 111 of the LED bulb 100 in a location that does not significantly block or impede the passive convective flow of the thermally conductive liquid.

FIGS. 4A and 4B depict cross-sectional views of an LED bulb 100 with an exemplary ring structure 140 placed in the enclosed volume 111. FIGS. 4A and 4B also depict exemplary convective currents in an LED bulb 100 placed in two different orientations. As shown in FIG. 4A, the profile of the ring structure 140 at least partially overlaps the dead zones 130 of the thermally conductive liquid. In some cases, the profile of the ring structure is approximately congruent with the dead zones 130.

A ring structure 140 positioned as shown in FIGS. 4A and 4B may facilitate convective flow of the thermally conductive liquid from the LEDs 103 to the inner surface of the shell 101. For example, as shown by the directional flow arrows in FIGS. 4A and 4B, when the ring structure 140 is installed as shown, cells of the thermally conductive liquid are able to pass by the surface of LEDs 103 to absorb heat produced by the LEDs 103. The cells of the thermally conductive liquid are also able to pass by the inner surface of the shell 101 and base 113 so that heat can be dissipated from the thermally conductive liquid to the environment. Thus, as shown in FIGS. 4A and 4B, the convective currents are not significantly impeded by the presence of the ring structure 140.

The ring structure 140 is positioned with respect to the LEDs 103 so that the light emitted from the LEDs 103 can be absorbed by the phosphor material integrated with the ring structure 140. In some cases, the ring structure 140 is shaped and placed in a location so that the ring structure 140 can intercept nearly all the light traveling on a path from the LEDs 103 to the shell 101. One advantage of such a ring structure 140 is that the light distribution produced by the LED bulb 100 appears more uniform. Exemplary ring structure embodiments are shown in FIGS. 6A, 6B, 7A, and 7B.

Additionally, because the ring structure is spatially separated from the LEDs 103, the phosphor material is not in direct contact with the LEDs 103. Keeping the phosphor material away from the LEDs 103 (and other hot elements in the LED bulb) may increase the life of the phosphor material.

In some embodiments, the ring structure 140 may be configured to facilitate the passive convective flow of the thermally conductive liquid when the LED bulb is in multiple orientations. For example, FIG. 5 depicts a front view of an LED bulb 100 in a horizontal orientation with a ring structure 140 installed. As indicated by the arrows in FIG. 5, the ring structure 140 includes channels that facilitate passive convective flow of the thermally conductive liquid when the LED bulb is positioned as shown in FIG. 5. With the ring structure 140 installed, the cells of the thermally conductive liquid are able to pass by the surface of LEDs 103 to absorb heat produced by the LEDs 103. The cells of the thermally conductive liquid are also able to pass through the channels of the ring structure 140 and to the inner surface of the shell 101 so that heat can be dissipated from the thermally conductive liquid to the surrounding environment.

FIGS. 6A and 6B depict one exemplary embodiment of a ring structure 142. In some cases, the dimension of the outer surface of the ring structure 142 is less than the dimension of the inner surface of the shell to facilitate passive convective flow of the thermally conductive liquid when the ring structure 142 is installed in an LED bulb. The minimum distance between the ring structure 142 and the shell depends on a number of factors, including the viscosity of the thermally conductive liquid, the surface roughness of the materials, and the temperature difference between the LED and the surrounding air. In some cases, the gap between the outer surface of the ring structure 142 and the inner surface of the shell is at least 2 mm.

In some cases, the dimension of the inner surface of the ring structure 142 is sized to provide a gap between the inner surface of the ring structure 142 and the LEDs, when the ring structure 142 is installed in the LED bulb. In some cases, the gap between the LEDs and the inner surface of the ring structure 142 is at least 2 mm.

The ring structure 142 depicted in FIGS. 6A and 6B also includes channels 150 that also facilitate passive convective flow of the thermally conductive liquid, when the LED bulb is placed in certain orientations. For example, as shown in FIG. 5, the channels 150 may facilitate passive convective flow of the thermally conductive liquid when the LED bulb is oriented horizontally. In some cases, the channels 150 may also facilitate passive convective flow of the thermally conductive liquid when the LED bulb 100 is oriented in positions as shown in FIGS. 4A and 4B. That is, the channels 150 allow cells of the thermally conductive liquid to pass by the inner surface of the shell and dissipate heat. In some cases, the channels 150 facilitate enough flow to enable the gap between the outer surface of the ring structure 142 and the inner surface of the shell to be very small or zero.

FIGS. 7A and 7B depict another exemplary embodiment of a ring structure 144. Similar to the ring structure 142 of FIGS. 6A and 6B, the dimensions of ring structure 144 are also sized to facilitate passive convective flow of the thermally conductive liquid when the ring structure 144 is installed in an LED bulb. For example, the ring structure 144 is sized to provide a minimum gap between the surface of the ring structure and shell and LED elements of the LED bulb.

The ring structure 144 of FIGS. 7A and 7B also includes channels 150 to facilitate passive convective flow of the thermally conductive liquid, when the LED bulb is placed in certain orientations. The ring structure 144 of FIGS. 7A and 7B also includes holes 160 that also facilitate passive convective flow by allowing the thermally conductive liquid to pass through the ring structure 144 when the LED bulb is in certain orientations.

A phosphor material can be deposited on the inside or outside surface of any ring structure embodiment (140, 142, or 144) included in the embodiments discussed above. In some cases, the ring structure (140, 142, or 144) is hollow and the phosphor material is deposited on the inside of the ring structure (140, 142, or 144). In some cases, the phosphor material is dispersed within the ring structure material.

The foregoing descriptions of specific embodiments of the present invention have been presented for purposes of illustration and description. They are not intended to be exhaustive or to limit the invention to the precise forms disclosed, and it should be understood that many modifications and variations are possible in light of the above teaching.

What is claimed is:

1. A liquid-filled light-emitting diode (LED) bulb comprising:
a base;
a shell connected to the base forming an enclosed volume;
a plurality of LEDs attached to the base and disposed within the enclosed volume;
a thermally conductive liquid held within the enclosed volume, the thermally conductive liquid having a first index of refraction; and
a ring structure disposed within the enclosed volume and immersed in the thermally conductive liquid, wherein the ring structure has a second index of refraction, and wherein the second index of refraction matches the first index of refraction; and
a phosphor material disposed on the ring structure,
wherein a first amount of the thermally conductive liquid is disposed between the LEDs and the ring structure and a second amount of the thermally conductive liquid is disposed between the ring structure and the shell.

2. The liquid-filled LED bulb of claim 1, wherein the second index of refraction of the ring structure is matched within 10 percent of the first index of refraction of the thermally conductive liquid.

3. The liquid-filled LED bulb of claim 1, wherein at least one of the plurality of LEDs has a third index of refraction, and the first index of refraction of the thermally conductive liquid is matched within 40 percent of the third index of refraction of the at least one LED.

4. The liquid-filled LED bulb of claim 1, wherein the ring structure is configured to facilitate a flow of the thermally conductive liquid from the LED to an inner surface of the shell.

5. The liquid-filled LED bulb of claim 4, wherein the flow of thermally conductive liquid is caused, at least in part, by passive convection.

6. The liquid-filled LED bulb of claim 4, wherein an inside surface of the ring structure is positioned a fixed distance from a light-emitting face of at least one of the plurality of LEDs to facilitate a flow of the thermally conductive liquid from the LED to an inner surface of the shell.

7. The liquid-filled LED bulb of claim 4, wherein an outside surface of the ring structure is positioned a fixed distance from an inner surface of the shell to facilitate a flow of the thermally conductive liquid from the LED to an inner surface of the shell.

8. The liquid-filled LED bulb of claim 1, wherein the phosphor material is configured to absorb light produced by the LEDs having a first wavelength and is configured to emit light at a second wavelength, the second wavelength being longer than the first wavelength.

9. The liquid-filled LED bulb of claim 1, wherein the phosphor material is disposed on an external surface of the ring structure.

10. The liquid-filled LED bulb of claim 1, wherein the phosphor material is disposed on an internal surface of the ring structure.

11. A liquid-filled light-emitting diode (LED) bulb comprising:
a base;
a shell connected to the base forming an enclosed volume;
a plurality of LEDs disposed within the enclosed volume;
a thermally conductive liquid held within the enclosed volume, the thermally conductive liquid having a first index of refraction; and
a ring structure disposed within the enclosed volume and immersed in the thermally conductive liquid, wherein the ring structure having a second index of refraction, and wherein the second index of refraction matches the first index of refraction; and
a phosphor material dispersed within the ring structure,
wherein a first amount of the thermally conductive liquid is disposed between the LED and the ring structure and a second amount of the thermally conductive liquid is disposed between the ring structure and the shell.

12. The liquid-filled LED bulb of claim 11, wherein at least one of the plurality of LEDs has a third index of refraction, and the first index of refraction of the thermally conductive liquid is matched within 40 percent of the third index of refraction of the at least one LED.

13. The liquid-filled LED bulb of claim 11, wherein the second index of refraction of the ring structure is matched within 10 percent of the first index of refraction of the thermally conductive liquid.

14. The liquid-filled LED bulb of claim 11, wherein the ring structure is configured to facilitate a flow of the thermally conductive liquid from the LED to an inner surface of the shell.

15. The liquid-filled LED bulb of claim 14, wherein the flow of thermally conductive liquid is caused, at least in part, by passive convection.

16. The liquid-filled LED bulb of claim 14, wherein an inside surface of the ring structure is positioned a fixed distance from a light-emitting face of at least one of the plurality of LEDs to facilitate a flow of the thermally conductive liquid from the LED to an inner surface of the shell.

17. The liquid-filled LED bulb of claim 14, wherein an outside surface of the ring structure is positioned a fixed distance from an inner surface of the shell to facilitate a flow of the thermally conductive liquid from the LED to an inner surface of the shell.

18. The liquid-filled LED bulb of claim 11, wherein the phosphor material is configured to absorb light produced by the LEDs having a first wavelength and is configured to emit light at a second wavelength, the second wavelength being longer than the first wavelength.

19. A method of making a liquid-filled light-emitting diode (LED) bulb comprising:
attaching a base to a shell to form an enclosed volume;
attaching a plurality of LEDs to the base, the plurality of LEDs disposed within the enclosed volume;
placing a ring structure within the enclosed volume, the ring structure having a first index of refraction, wherein a phosphor material is disposed on or dispersed within the ring structure; and
filling the enclosed volume with a thermally conductive liquid, the thermally conductive liquid having a second index of refraction, wherein the second index of refraction matches the first index of refraction,
wherein a first amount of the thermally conductive liquid is disposed between the LEDs and the ring structure and a second amount of the thermally conductive liquid is disposed between the ring structure and the shell.

20. A method of making a liquid-filled LED bulb of claim 19, wherein the second index of refraction of the ring structure is matched within 10 percent of the first index of refraction of the thermally conductive liquid.
